(19) United States
(12) Patent Application Publication
(10) Pub. No.: US 2009/0294411 A1
(43) Pub. Date: Dec. 3, 2009

(54) SYSTEM FOR AND METHOD OF PROJECTION WELD-BONDING WORKPIECES

(76) Inventor: Alexander D. Khakhalev, Troy, MI (US)

Correspondence Address: GENERAL MOTORS COMPANY;LEGAL STAFF, MAIL CODE 482-C23-B21, P O BOX 300, DETROIT, MI, 48265-3000, US

(21) Appl. No.: 12/120,630

(22) Filed: May 14, 2008

Related U.S. Application Data
(63) Continuation-in-part of application No. 11/937,518, filed on Nov. 9, 2007.

(51) Int. Cl. B23K 11/00; B32B 3/00

(52) U.S. Cl. 219/117.1; 428/156

(57) ABSTRACT

A system for and method of projection weld-bonding a plurality of workpieces, includes the steps of securing at least one adhesive layer having a plurality of projections embedded therein intermediate the workpieces, and engaging the workpieces with a resistance welding apparatus such that only the projections fuse to form the weld pool, and the layer cures to form an adhesive seal around the welds, together the adhesive layer and projections cooperatively forming a reinforced joint.

### CROSS-REFERENCES TO RELATED APPLICATIONS

This U.S. Non-Provisional patent application claims the benefit of and is a continuation-in-part from pending U.S. Non-Provisional application Ser. No. 11/937,518, entitled SYSTEM FOR AND METHOD OF PRODUCING INVISIBLE PROJECTION WELDS filed on Nov. 9, 2007.

### BACKGROUND OF THE INVENTION

1. Field of the Invention

The present invention relates to resistance welding systems and bonding methods, and more particularly concerns a resistance welding system for and method of weld-bonding a plurality of workpieces utilizing projections embedded within an adhesive layer.

2. Discussion of Prior Art

Resistance mash welding (e.g., conventional spot or seam welding) remains the most common method of joining metallic workpieces in various industries, including automotive manufacture and construction. In this method, the workpieces 1,2 are typically secured in a fixed condition, and then engaged by two electrodes 3,4, as shown in FIG. 1. The electrodes 3,4 function to co-extensively transmit a sustained force and an electric current through the workpieces until the combined resistance at their interface generates sufficient heat energy to produce a molten weld pool therebetween. Undesirably, however, exterior anomalies and aesthetic concerns are also often experienced. For example, depressions 5 caused by the force exuded upon the workpieces (FIG. 1a), whiskers (i.e., short pieces of material sticking through the root side of the weld joint), and spatters (i.e., satellites formed by loose droplets of molten material during welding) are just a few of the common by-products of resistance welding processes.

These aesthetic concerns are typically addressed during a finishing process, wherein depressions are filled and surfactants are milled prior to painting. Invariably, however, these finishing processes result in increased costs, including but not limited to additional material and labor. The need to address aesthetic concerns also results in a longer period of manufacture, thereby impacting productivity. Even where a finishing process is provided, traces of the exterior anomalies remain and are often easily detectable through the paint.

Finally, another concern relating to fusion welding involves the production of relatively brittle inter-metallic areas that form within the joint when workpieces of dissimilar material (such as aluminum and steel) are melted together. These areas typically present lower load bearing strength in comparison to the homogenous areas of the joint.

More recently, other methods of metallurgically joining workpieces have been developed that utilize other less aesthetically impacting technology, such as thermal laser brazing, some forms of solid state (e.g., friction, ultrasonic, or explosive) welding, and diffusion bonding. It is appreciated, however, that these methods present more complex and therefore costly technologies in comparison to conventional resistance welding. As such, these technologies have achieved limited market penetration and are relegated to relatively small subsets of applications.

Yet another conventional method of joining workpieces is adhesive bonding. This method utilizes an epoxy or adhesive layer to join the workpieces 1,2. It is appreciated that adhesive bonding does not require the energy input of welding to coalesce the base material and thereby form the joint. It is further appreciated that, adhesive bonding forms a better seal that separates the interior of the assembly from outside contaminants, and results in less surface deformation than do prior art welding applications of comparable extent. However, it is also appreciated that this method of joining typically provides lower overall strength in comparison to welded joints.

Thus, there remains a need in the art for a facilely implemented method of joining a plurality of workpieces that combines the benefits of welding and adhesive bonding applications, and more particularly, reduces exterior surface anomalies and aesthetic concerns, while maintaining the superior strength of welding and the protective seals of adhesive bonding.

### BRIEF SUMMARY OF THE INVENTION

Responsive to this need, an improved method of weld-bonding a plurality of similar or dissimilar workpieces that eliminates exterior surface anomalies is presented. The method involves the use of an adhesive layer having a plurality of projections embedded therein. The inventive system and method disclosed herein is useful among other things for providing a facilely implemented solution that requires no new or additional resistance welding equipment.

The method is useful for producing invisible fusion welds, which makes it ideal for exterior product welds (i.e., welds wherein the exterior surface of one or both of the engaged workpieces present an exterior product surface). It is appreciated that decreasing the amount of and more preferably eliminating exterior surface anomalies reduces the need for and extent of a finishing process, and thereby results in a reduction of the afore-mentioned costs.

The method is further useful for providing a sealed joint that forms a barrier to outside contaminants, such as oil, grease, water, and particulate matter. The inventive method produces a combined welded and adhesively bound joint that presents greater structural strength in comparison to welding or adhesive bonding individually. Where used in an automotive setting, such as roof deck construction, it is also appreciated that the invention produces better weld quality in that a larger bonding area is realized, and enables the roof ditch width to be reduced. Finally, it is appreciated that the inventive process of embedding a plurality of projections in a layer of adhesive material eliminates the time consuming need to fabricate the projections, and thereby eliminates the need for a fabrication station and/or hardware.

A first aspect of the invention concerns a method of weld-bonding a plurality of workpieces defining apposite exterior most surfaces utilizing at least one continuous adhesive layer comprising adhesive material and a plurality of projections embedded therein. The method comprises the steps of securing the layer in a welding position relative to one of the workpieces, and then securing the remainder of the workpieces relative to the layer and workpieces, so as to present a fixed relative condition. In the condition, each projection and the layer(s) are intermediately positioned between adjacent workpieces, such that each projection and the adjacent workpieces cooperatively define at least one initial axis of engagement. The method generally concludes by appositely engaging the surfaces along the axis with a resistance welding apparatus to deform and fuse the projections, and heat the adhesive material past a minimum temperature, so as to cooperatively form the joint.

Thus, a second aspect of the invention concerns an article of manufacture adapted for use with the inventive weld-bonding process. The article of manufacture comprises a layer of adhesive material and a plurality of spaced metal projections embedded therein.

Other aspects and advantages of the present invention, including preferred projection configurations, as well as methods performing the associative weld-bonding will be apparent from the following detailed description of the preferred embodiment(s) and the accompanying drawing figures.

### BRIEF DESCRIPTION OF THE SEVERAL VIEWS OF THE DRAWING

Preferred embodiments of the invention are described in detail below with reference to the attached drawing figures, wherein:

FIG. 1 is an elevation view of a prior art resistance spot welding apparatus and a plurality of workpieces, in a before welding condition;

FIG. 1a is an elevation view of the prior art apparatus and the workpieces shown in FIG. 1, in an after welding condition, particularly illustrating exterior surface depressions;

FIG. 1b is an elevation view of a prior art welding apparatus having a “C”-shaped structural frame;

FIG. 2 is an elevation view of a resistance welding system in accordance with a preferred embodiment of the present invention, wherein a free-body projection presenting a circular cross-sectional configuration is intermediately positioned between first and second workpieces;

FIG. 2a is an elevation view of the system shown in FIG. 2, after the welding force and before the current load have been applied to the workpieces and projection;

FIG. 2b is an elevation view of the system shown in FIG. 2, after the welding force and current load have been applied to the workpieces and projection;

FIG. 3 is an elevation view of a free-body projection having spaced top and bottom curvilinear surfaces in accordance with a preferred embodiment of the present invention, intermediately positioned between first and second workpieces;

FIG. 4 is a perspective view of a free-body projection having a diamond cross-section with chamfered edges in accordance with a preferred embodiment of the present invention engaged by a dual-electrode welding apparatus (in partial view), particularly illustrating projection-workpiece and electrode-workpiece interfaces;

FIG. 4a is an elevation view of the projection and workpieces shown in FIG. 4, particularly illustrating the projection intermediately positioned between first and second workpieces;

FIG. 5 is a perspective view of an annular projection having a square horizontal cross-section, in accordance with a preferred embodiment of the present invention;

FIG. 6 is a perspective view of an annular projection having a circular horizontal cross-section, in accordance with a preferred embodiment of the present invention;

FIG. 7 is a perspective view of a free-body projection having an “H”-shaped vertical cross-section, in accordance with a preferred embodiment of the present invention;

FIG. 8 is an elevation view of the projection shown in FIG. 7;

FIG. 9 is a perspective view of a lower workpiece, a projection recently placed in the welding position, and a roll dispenser comprising a dispensing reel, a wound tape having a plurality of embedded projections therein, a projection ejector, and a receiving reel, in accordance with a preferred embodiment of the invention;

FIG. 10 is a side elevation view of a portion of the tape shown in FIG. 9;

FIG. 10a is a cross-section of the portion of tape shown in FIG. 10, taken along the line A-A therein;

FIG. 11 is a perspective view of a lower workpiece, a projection and an encircling portion of tape recently placed in the welding position, and a roll dispenser comprising a dispensing reel, a wound tape having a plurality of embedded projections therein, a modified projection ejector and tape cutter, and a receiving reel, in accordance with a preferred embodiment of the invention;

FIG. 12 is a schematic elevational view of a plurality of workpieces, an adhesive layer having embedded spherical projections therein, and a plurality of electrodes in a before weld-bonding condition, in accordance with a preferred embodiment of the present invention;

FIG. 12a a schematic elevational view of the workpieces, layer, projection and electrodes shown in FIG. 12, in a post weld-bonding condition;

FIG. 13 is a planar view of an elongated layer, particularly illustrating a plurality of spherical projections, adhesive material, and constant projection spacing, in accordance with a preferred embodiment of the invention;

FIG. 13a is a planar view of a cross-shaped layer having reduced projection spacing adjacent the outermost lateral edges, in accordance with a preferred embodiment of the invention; and

FIG. 13b is a planar view of a layer presenting a planar sheet configuration, particularly illustrating a plurality of elongated projections or wires in a mesh configuration, and discontinuous adhesive material in a radial band pattern, in accordance with a preferred embodiment of the invention.

### DETAILED DESCRIPTION OF THE INVENTION

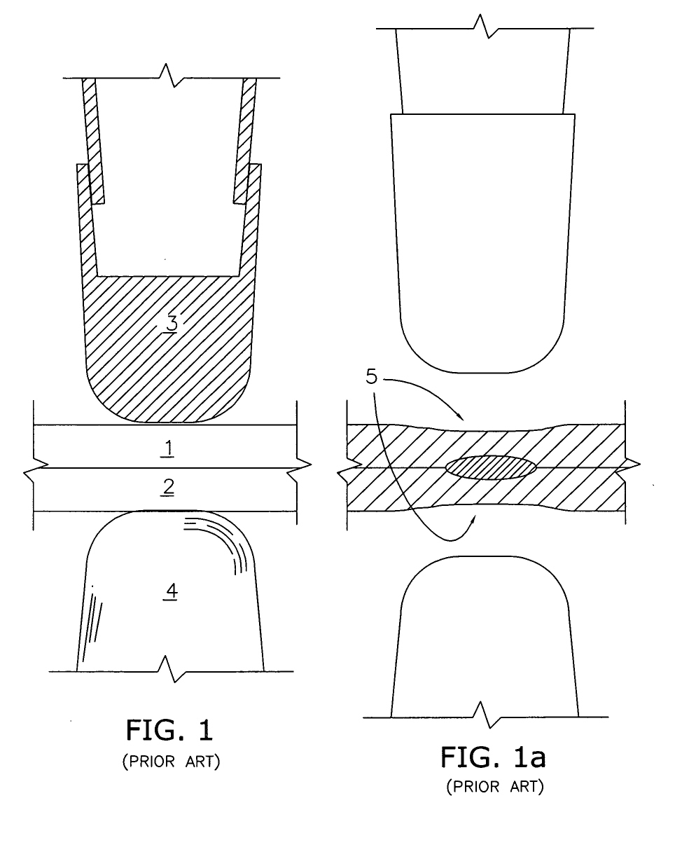

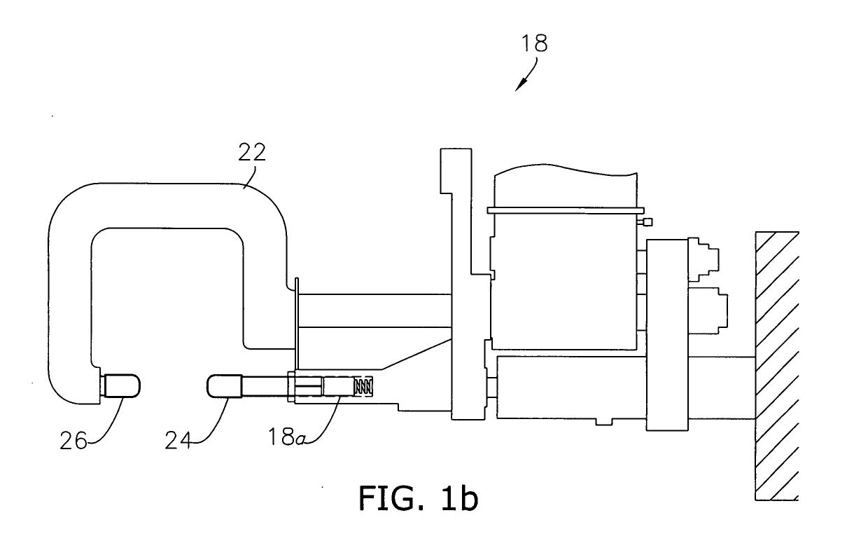

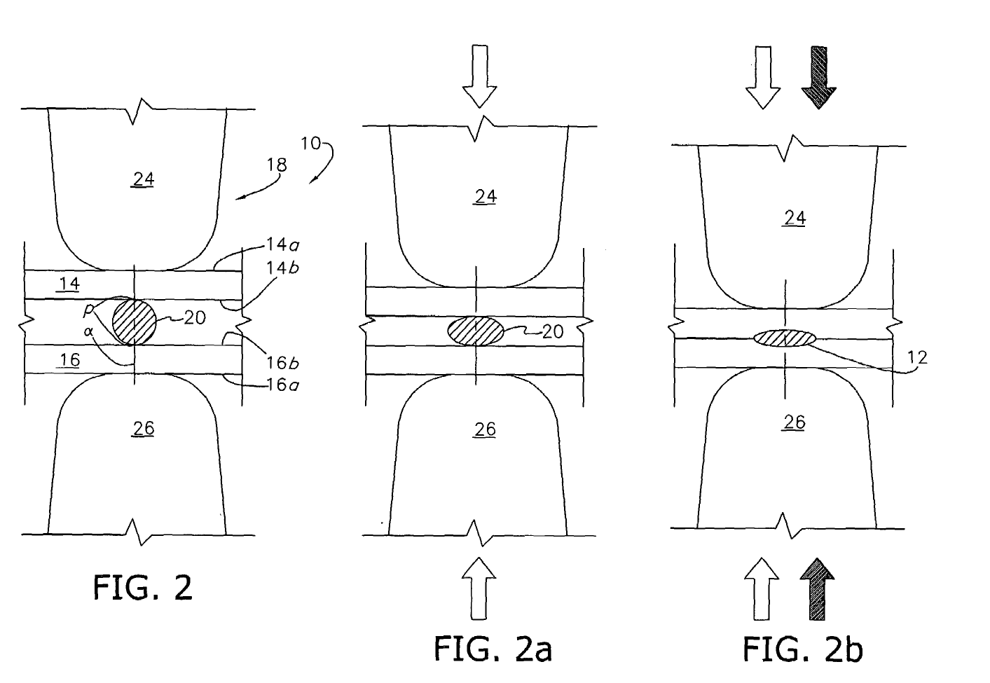

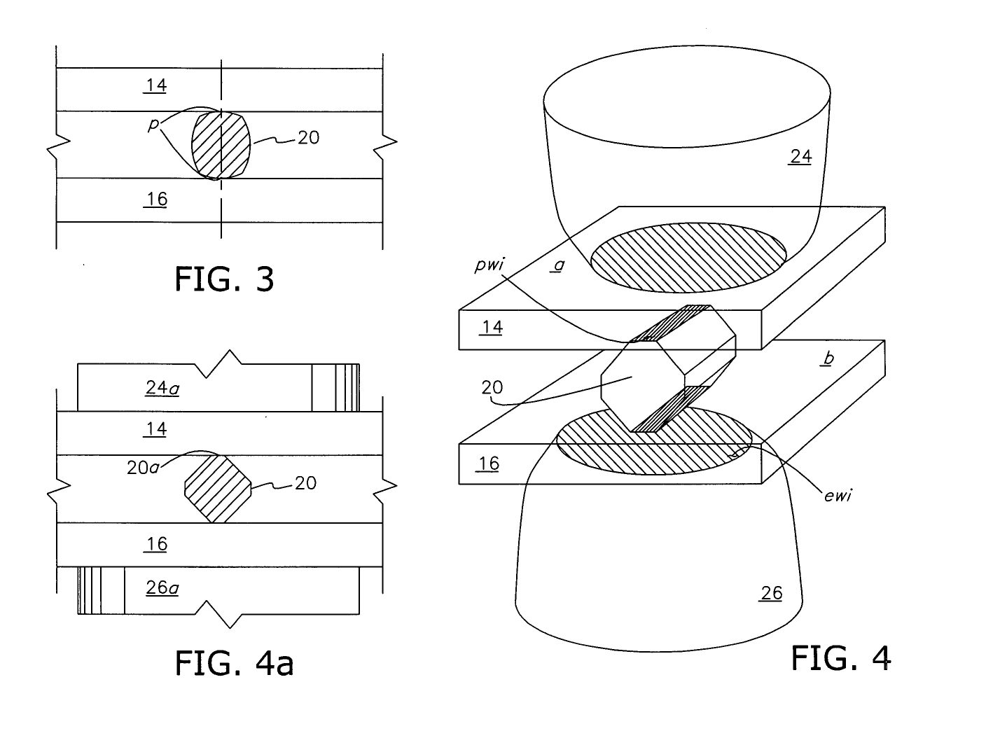

The present invention concerns a system 10 (FIGS. 2-13b) for and method of producing an invisible spot or seam weld 12 (FIG. 3) between a plurality of workpieces 14,16, such as a two-sheet “stack-up” of automotive sheet metal. The inventive system 10 is configured to produce the invisible weld 12 respective to the exterior of the constructed workpiece assembly (compare FIGS. 1a and 2b). That is to say, exterior surface deformations or anomalies, such as surface depressions, are not formed during the inventive resistance welding method described herein. It is appreciated that the invention, therefore, increases the aesthetic appeal and reduces manufacturing costs associated with the assembled product. The invention is adapted for use with conventional resistance mash welding devices, such as the apparatus 18 generally depicted in FIG. 1b, and does not require additional welding equipment and/or modifications.

In the illustrated embodiments, a plurality of two workpieces 14,16 of equal thickness is shown; however, the inventive system 10 may be utilized to invisibly weld a greater plurality, or structural components having variable thickness or otherwise configuration by modifying and applying the teachings of the system 10 as required. The workpieces 14,16 preferably present planar configurations (FIGS. 2 and 4) defining generally flat surfaces and peripheral edges, and may be formed of a wide range of metals, including steel and aluminum alloy. In the welding position, the workpieces 14,16 present oppositely engageable exterior surfaces 14a,16a, and interior surfaces 14b,16b apposite and parallel to the respective exterior surface (FIG. 2).

As illustrated and further described herein, the inventive weld 12 is produced by engaging at least one free-body projection 20 positioned intermediate the workpieces 14,16 with a resistance welding apparatus 18. The apparatus 18 may present a single-sided welding apparatus, so as to streamline the assembly process. In this configuration, a conductive backing block (not shown) may be provided to support the lower workpiece 16 either adjacent the weld 12 or at a convenient location spaced from the joint. If the workpieces 14,16 and projection 20 present sufficient stiffness, then a support is not necessary.

More preferably, the system 10 includes a dual-electrode welding apparatus 18 (as generally shown in the illustrated embodiments), such as the type having a “C”-shaped structural frame 22 (FIG. 1b). In this configuration, the apparatus 18 includes a first electrode 24, a transport mechanism (not shown), and an identical back-up electrode 26. As known in the art, the electrodes 24,26 oppositely engage the workpieces 14,16, to cooperatively impart a welding force thereupon and complete an electric potential. Thus, the electrodes 24,26 are preferably configured to contact the workpiece surfaces 14a,16a adjacent the projection 20, so as to maximize the applied force to and minimize the travel path of the current through the projection 20. As further described herein, the preferred apparatus 18 is operable to transmit the force and current load non-concurrently, wherein the force drive mechanism (also not shown) is actuated first.

Where seam welding is desired, the apparatus 18 includes wheel electrodes that rollingly engage the workpieces 14,16, as known in the art. The projection width is preferably less than the electrode wheel width, but a maximum lateral dimension is not defined. In this configuration, it is appreciated that elongated and even complex sinuous welds can be produced. It is also appreciated that the invention provides the added benefits of determining the precision of weld formation by the placement and configuration of the projection rather than by the accuracy of the electrode wheel path.

The interior surfaces 14b,16b of the workpieces are spaced by and abut the free-body projection 20. As a result, the projection 20 and workpieces 14,16 cooperatively define top and bottom points of contact, p, and at least one axis of engagement, α, passing through the points (FIG. 2). As previously mentioned, once the projection 20 has been properly positioned, and the workpieces 14,16 and projection 20 are secured in a relatively fixed condition (e.g., by clamping), the exterior surfaces 14a,16a are engaged by the welding apparatus 18, so as to transmit the force and current co-axially with the axis or axes of engagement. It is appreciated that an adhesive 20a affixed to the projection 20 or the workpieces 14,16, or magnetism may be utilized to help retain the projection in the welding position (prior to clamping).

The preferred projection 20 and workpieces 14,16 are cooperatively configured such that the projection 20 deforms and completely fuses prior to any deformation of the workpieces 14,16 at or near their exterior surfaces 14a,16a. To that end, the projection 20 consists of material having a mean melting temperature less than that of the workpiece material(s); and more preferably less than ninety percent of the melting temperature of the workpiece material. Once molten, the projection 20 predominately forms the weld pool. It is appreciated, however, that a small quantity of workpiece material also fuses along the projection-workpiece interfaces, as part of a “wetting” process. The wetting process enables the formation of metallurgical bonds between the projection 20 and workpieces 14,16.

Suitable projection materials include mild steel, aluminum alloys, silicon-bronze wire, or a combination thereof. The applied material is selected based upon the physical and chemical properties, including the relative “wettability,” hardness and melting temperatures, of the workpiece material(s). For example, where the workpiece material is electrogalvanized steel, a silicon-bronze projection 20 is preferably utilized, as it is appreciated that such combination of materials produce sufficient wetting along the projection-workpiece interfaces. In another example, where the workpieces 14,16 are formed of hard steel, the projection 20 preferably consists of mild steel having a 5 to 10 micron (i.e., 10⁻⁶ m) thick electrogalvanized zinc coating, as it is appreciated that the zinc coating facilely wets brazed workpiece material.

To further prevent exterior surface deformation, the projection 20 is configured so as to present minimal top and bottom projection-workpiece interfaces, as determinable by the lateral cross-section and depth of the projection 20. Each projection-workpiece interface, pwi, presents an area substantially smaller than (e.g., less than seventy-five, and more preferably less than twenty-five percent of) each of the electrode-workpiece interfaces, ewi (FIG. 4). The projection 20 presents a width profile, as measured along its height, h, that maintains this ratio as the projection fuses. It is appreciated that the smaller areas of the projection-workpiece interfaces compared to the areas of the electrode-workpiece interfaces, result in greater pressure being exerted upon the projection 20. More preferably, to further increase this ratio, modified top and bottom electrodes 24a,26a (FIG. 4a) defining flat workpiece engaging surfaces substantially (e.g., 1.5 to 3 times) greater in diameter than those of standard size electrodes are utilized.

In one suitable configuration, the projection 20 presents curvilinear engagement surfaces that provide singular points of contact, p. For example, the projection 20 may define a purely circular cross-section, as shown in FIG. 2. Alternatively, the curvilinear surfaces may be vertically spaced or elongated as shown in FIG. 3, so as to increase projection volume, maintain a single lateral point of contact, and reduce the maximum lateral projection width. It is appreciated that an initial single point of contact, as in a spherical or ellipsoidal projection 20 maximizes the pressure at and therefore minimizes the welding force required to initially deform the projection 20.

Other projection configurations include polygonal cross-sectional shapes, such as the diamond configuration shown in FIGS. 4 and 4a. In this configuration, the edges of the diamond are preferably chamfered to present flat workpiece engaging surfaces 20a not more than 1 mm in width; and the projection 20 is oriented so as to engage the workpieces 14,16 along the flat engaging surfaces 20a.

The projection 20 further defines an overall longitudinal length, l (FIG. 7) that changes during fusion based on the longitudinal configuration of the projection versus the height of engagement. In this regard, it is appreciated that a segment of wire, for example, presents a generally constant l, while a spherical projection 20 will present a constantly changing l as it fuses. The height (FIG. 8) and length (FIG. 7) of the projection 20 are sized to produce the desired weld joint size/area, and are more specifically determined based on the workpiece material and application. For example, where the workpieces 14,16 consists essentially of steel, the workpiece thickness is between 0.6 and 2 mm, and the application makes the provision of an effective joint highly critical, the projection length is preferably within the range 5 to 20 mm. More preferably, the projection length is approximately 9 mm for workpiece thickness within a range of 0.6 to 1.2 mm, and approximately 12 mm within a range of 1.2 to 2 mm. The projection diameter is within the range 0.6 to 2 mm, and is more preferably 0.9 mm for workpiece thickness within the range 0.6 to 1.2 mm, and 1.4 mm for thickness within the range 1.2 to 2 mm.

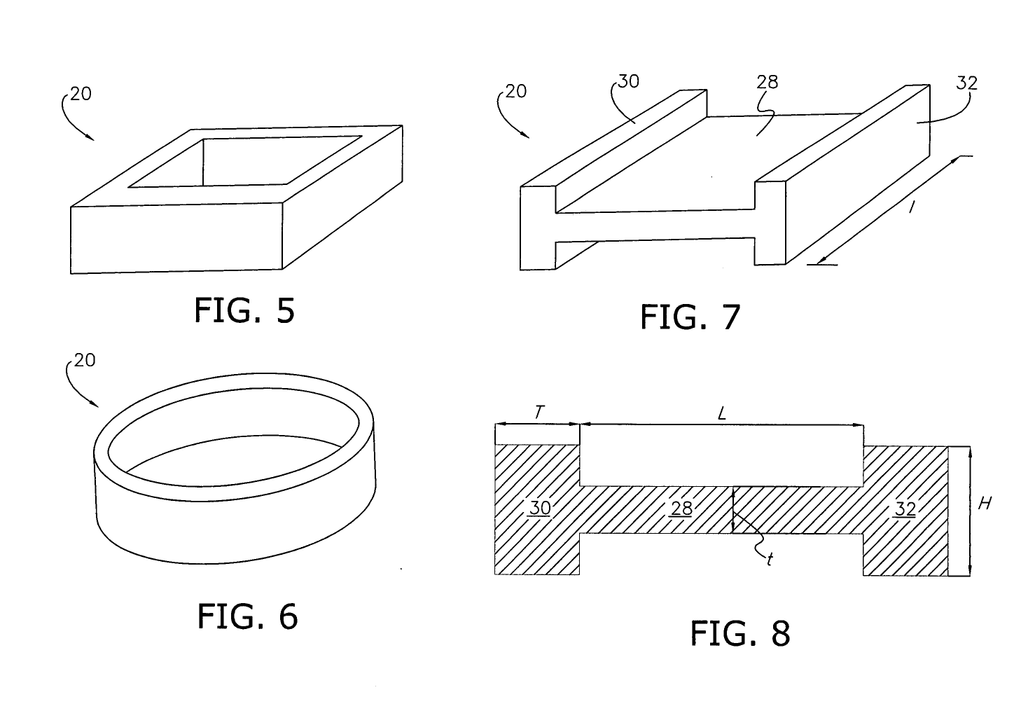

In another embodiment, the projection 20 may present an annular longitudinal configuration having a wall thickness within the range of 1 to 3 mm. Shown in FIGS. 5 and 6 are square and circular embodiments of this configuration. Where spot welding is to be performed, the annular projection 20 presents a maximum outside diameter not greater than the minimum lateral dimension of the electrode-workpiece interfaces. It is appreciated that in this configuration the weld footprint (i.e., effective area of the weld) is maintained, even though the amount of projection material to be fused, and therefore welding force and current load required are reduced.

Finally, in yet another embodiment shown in FIGS. 7-9, the projection 20 may present an “H”-shaped vertical cross-section formed by a cross member 28 that bisects and interconnects two preferably parallel outer members 30,32. In this configuration, the projection 20 is oriented so as to engage the workpieces 14,16 along the tops and bottoms of the parallel outer members 30,32. Thus, initial projection-workpiece interfaces, in this configuration, are limited to the wall thickness, T, and depth, d. As shown in FIG. 8, the cross member 28 presents a width, l, and a height or thickness, t; while the outer members 30,32 further present a height, h. More preferably, the cross member length and outer member height are cooperatively configured, such that l is equal to h times a multiple within the range of 3 to 8. For example, h may be within the range of 0.7 to 2 mm, T within the range of 0.5 to 1.5 mm, l within the range of 3 to 8 mm, t within the range of 0.2 to 0.5 mm, and d within the range of 0.6 to 1.2 mm.

In operation, the weld 12 is preferably formed by a welding apparatus 18 operable to transmit the welding force for a minimum period (e.g., 300 ms) prior to transmitting the current load (FIGS. 2-2b). As shown in intermediate FIG. 2a, it is appreciated that under a pure force load the projection 20 may undergo noticeable deformation, as occasioned by a harder workpiece material. More preferably, however, the projection 20 does not show deformation under the applied force load. It is appreciated that the generated stresses also facilitate fusion once the current load is applied, which thereby results in energy conservation. The force and current loads are then concurrently applied for a sustained period sufficient to fuse the projection 20 (e.g., 5 to 50 ms). Immediately upon the complete fusion of the projection 20, the force and current loads are terminated, so that deformation does not begin to form at the exterior surfaces 14a,16a (FIG. 2b). Both periods are preferably optimized through trial and error for a given application (i.e., set of variables) and recorded in a storage medium (not shown).

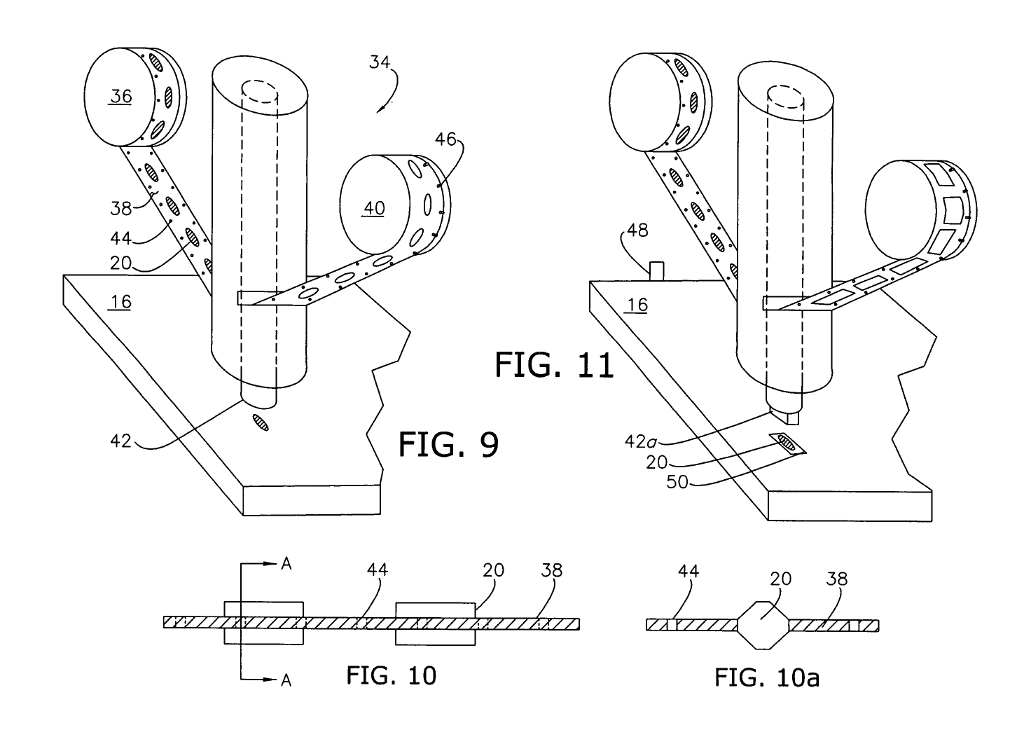

In a second mode of operation, the preferred system 10 is configured to autonomously position the projection 20 in an assembly-line setting; and to that end, includes a roll dispenser 34, such as the type used to place rivets during conventional rivet bonding applications. As shown in FIGS. 9-11, the roll dispenser 34 includes a dispensing reel 36 storing a wound tape 38 having a plurality of equally spaced embedded projections 20 therein, and a receiving reel 40. An ejector (or “gun”) 42 is utilized to remove the projections from the tape 38 (FIG. 9). The dispenser 34 is configured to translate into a placement position once the lower workpiece 16 has been properly secured, and out of the placement position once a projection 20 has been properly ejected and positioned. After the upper workpiece 14 is secured atop the projection 20, the weld 12 is produced, the joined workpieces 14,16 are removed, and a new lower workpiece 16 has been properly secured, the tape 38 is advanced one projection spacing, and the dispenser 34 is re-turned to the placement position. In an exemplary configuration (FIGS. 9-11), the tape 38 is advanced by drabbing a plurality of periphery holes 44 defined by the tape 38 with prongs 46 presented by the receiving reel 40. Alternatively, it is appreciated that the dispenser 34 may present a fixed station, wherein the workpiece and newly positioned projection 20 perform the translation. The tape may be 10 to 15 mm wide and 0.5 mm thick.

The dispenser 34 and apparatus 18 are preferably programmably controlled, and present a closed-loop feedback control system 10. In this configuration, for example, the system 10 may further include at least one sensor 48 (FIG. 11) operable and oriented to detect whether the workpieces 14,16 and/or projection 20 has been properly positioned. The sensor 48 is communicatively coupled (e.g., connected by hard-wire or short-range wireless technology) to the dispenser 34 and apparatus 18 through a controller (not shown). It is appreciated that this facilitates a mass assembly process, wherein invisible projection welding is performed to join a large plurality of sets of workpieces over a welding period. Moreover, the system 10 may be programmably configured to access the storage medium, so as to recall previously determined optimized periods for a given application.

In a third mode of operation, the tape 38 is formed of material that forms an adhesive sealant when heated to a minimum temperature. In this configuration, the mode further includes positioning the projection 20 and an encircling portion 50 of the tape in the weld position. The portion 50 is produced, for example, by cutting the portion 50 from the remainder of the tape 38 with a modified ejector 42a (FIG. 11). The portion 50 is secured in the fixed condition in addition to the still embedded projection 20. When the workpieces 14,16 are engaged by the welding apparatus 18 to fuse the projection 20, the portion 50 is heated to the minimum temperature. As a result, an adhesive barrier is formed that completely encases the weld 12, and once cured during a finishing/painting process, further bonds the workpieces 14,16. Thus, it is appreciated that this configuration significantly increases the capacity of the joint and seals it from harmful impurities, such as moisture, oil, and dirt, and conditions, such as galvanic corrosion.

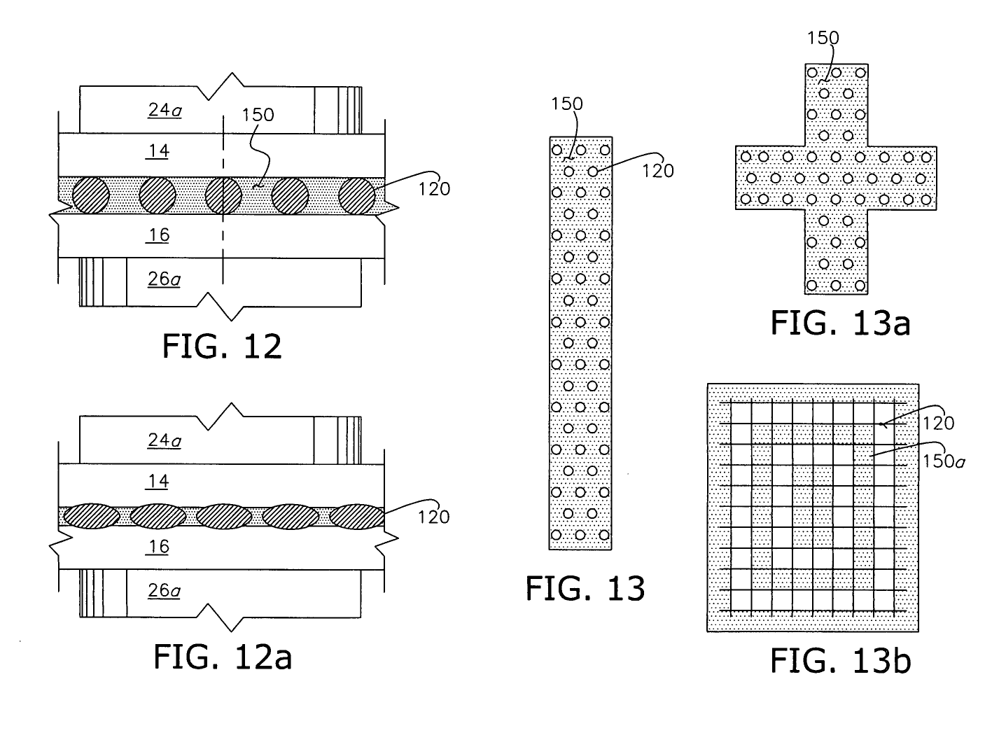

In continuation, it is appreciated that the later configuration may include a plurality of projections 120, as shown in FIG. 12. More particularly, FIGS. 12 and 12a show an adhesive layer 150 having a plurality of projections 120 embedded therein, in pre and post weld-bonding conditions. The layer 150 is interposed between, so as to be tangibly engaged to both workpieces 14,16, along surface areas of engagement. The preferred layer 150 consists of an epoxy based adhesive material. In the welding position, the layer preferably presents an elongated shape defining a longitudinal axis equal to that of the desired joint; however, it is well within the ambit of the invention for alternative configurations to be utilized such as a planar sheet, or the cross-shaped configuration shown in FIG. 13a.

As shown in FIG. 12, the projections 120 are preferably symmetrically spaced, and, where defining an average diameter, spaced a distance not less than half the diameter, so that each projection 120 freely expands during fusion and does not engage adjacent projections 120 (FIG. 12a). However, it is appreciated that the spacing of the projections 120 may vary along the longitudinal length or lateral width of the layer 150. For example, the spacing may be reduced towards the edges of the layer 150 in order to provide a stronger joint that is better configured to withstand peeling forces at these locations (FIG. 13a).

The projections 120 are of predetermined size (correlative to spacing), and more preferably present diameters within the range 0.5 to 1 mm. The projections 120 are formed of metal typical used during fusion welding (e.g., electro-galvanized zinc coating, aluminum alloys, steel, etc.), and more preferably consist essentially of silicon-bronze alloy. It is appreciated that the projections may be identical or present dissimilar constituencies where an aggregate joint is desired.

Also shown in FIGS. 12-13a, each projection 120 is preferably spherical in shape, so that a single initial axis of engagement is defined between the projection 120 and workpieces 14,16. However, as previously mentioned, the projections 120 may present alternative configurations, such as polygonal, cylindrical and ellipsoidal shapes, wherein a plurality of initial axes of engagement are defined. Moreover, where the layer 150 presents a planar sheet configuration, the projections 120 may present elongated wire configurations, oriented in a mesh, as shown in FIG. 13b. Where a mesh is utilized, it is appreciated that the planar sheet layer may present discontinuous regions of adhesive material, such as the radial bands 150a also shown in FIG. 13b.

Where weld-bonding sheet metal, such as the roof of a vehicle, to a bottom sheet, such as the body side of the vehicle, it is appreciated that the present invention results in expanding the bonding area, and more particularly, in expanding to the footprint area of the electrodes (e.g., 20 mm×7 mm). The electrodes 24a,26a and layer 150 are therefore cooperatively configured accordingly. Alternatively, it is further appreciated that the electrodes 24a,26a may engage only a portion of the layer 150 at a time to sequentially form the joint. More preferably, where the electrodes 24a,26a present electrode wheels, the wheels present a lateral width greater than that of the layer 150, and are operable to rollingly engage the workpieces 14,16 along the longitudinal axis of the layer 150, so that welding is performed along the entire length of the joint in a single pass.

Thus, in operation, the adhesive layer 150 is applied to a pre-positioned lower workpiece 16 such as the body side of a vehicle; the upper workpiece 14, such as the roof of the vehicle, is then positioned over the layer 150 and secured relative thereto; and lastly the layer 150 is welded using the welding apparatus 18 in the multi-step mode previously described. Finally, because the adhesive layer 150 including the embedded projections 120 cover the entire area of the joint, the welding electrodes 24a,26a can be disengaged from the projection locations, as it is appreciated that electrode positioning need not be as precise as in the case of traditional projection welding.

The preferred forms of the invention described above are to be used as illustration only, and should not be utilized in a limiting sense in interpreting the scope of the present invention. Obvious modifications to the exemplary embodiments and modes of operation, as set forth herein, could be readily made by those skilled in the art without departing from the spirit of the present invention. The inventor hereby states his intent to rely on the Doctrine of Equivalents to assess the scope of the present invention as pertains to any apparatus, system or method not materially departing from the literal scope of the invention set forth in the following claims.

What is claimed is:

1. A method of weld-bonding a plurality of workpieces defining apposite exterior most surfaces utilizing at least one layer comprising adhesive material and a plurality of embedded free-body projections, said method comprising the steps of:
a. securing said at least one layer in a welding position relative to one of said plurality of workpieces;
b. securing the remainder of the workpieces relative to said at least one layer and said one of said plurality of workpieces, so as to present a fixed relative condition, wherein each projection and said at least one layer are intermediately positioned between adjacent workpieces, such that each projection and the adjacent workpieces cooperatively define at least one initial axis of engagement; and
c. oppositely engaging the surfaces along said at least one axis with a resistance welding apparatus to deform and fuse the projections, and heating the adhesive material past a minimum temperature, so as to cooperatively form a joint.

2. The method as claimed in claim 1, wherein each projection presents a spherical configuration defining a single initial axis of engagement with the workpieces.

3. The method as claimed in claim 2, wherein each projection presents a spherical configuration having a diameter within the range 0.5 to 1 mm.

4. The method as claimed in claim 1, wherein each projection presents a cylindrical shape, and defines a plurality of initial axes of engagement with the workpieces.

5. The method as claimed in claim 1, wherein each projection is formed of material selected from the group consisting essentially of mild steel having an electro-galvanized zinc coating, aluminum alloys, and silicon-bronze alloy.

6. The method as claimed in claim 1, wherein at least two projections are formed of dissimilar material.

7. The method as claimed in claim 1, wherein each projection presents a mean melting temperature less than ninety percent of the mean melting temperature of the workpieces.

8. The method as claimed in claim 1, wherein the workpieces are formed of hard steel, and each projection is formed of mild steel having a 5 to 10 micron thick electro-galvanized zinc coating.

9. The method as claimed in claim 1, wherein the layer presents a lateral and longitudinal dimension, each projection presents an average diameter, and the projections present constant spacing not less than half the diameter along the longitudinal and lateral dimensions of the layer.

10. The method as claimed in claim 1, wherein the layer defines lateral edges and the projections define a first spacing within a central portion of the layer and a second spacing less than the first adjacent the lateral edges.

11. The method as claimed in claim 1, wherein the layer defines longitudinal edges and the projections define a first spacing within a central portion of the layer and a second spacing less than the first adjacent the longitudinal edges.

12. The method as claimed in claim 1, wherein the layer presents a lateral dimension, and the electrodes present electrode wheels having a width greater than the lateral dimension and configured to rollingly engage the workpieces.

13. The method as claimed in claim 1, wherein the layer presents a planar sheet, and the projections present a meshed wire configuration.

14. The method as claimed in claim 1, wherein the layer comprises a plurality of discontinuous radial bands of adhesive material.

15. The method as claimed in claim 1, wherein the layer presents a planar cross-shaped configuration.

16. A method of weld-bonding a plurality of workpieces defining apposite exterior most surfaces utilizing at least one continuous epoxy based adhesive layer and a plurality of spherical embedded projections formed of silicon-bronze alloy, said method comprising the steps of:
a. securing said at least one layer in a welding position relative to one of said plurality of workpieces;
b. securing the remainder of the workpieces relative to said at least one layer and said one of said plurality of workpieces, so as to present a fixed relative condition, wherein each projection and said at least one layer are intermediately positioned between adjacent workpieces, such that each projection and the adjacent workpieces cooperatively define at least one initial axis of engagement; and
c. oppositely engaging the surfaces along said at least one axis with a resistance welding apparatus having electrode wheels, and rolling the wheels along the longitudinal axis of the layer, so as to deform and fuse the projections, and heating the layer past a minimum temperature to cooperatively form a joint.

17. An article of manufacture adapted for use with a weld-bonding process, and comprising a layer of adhesive material and a plurality of spaced metal projections embedded within the layer.

18. The article of manufacture claimed in claim 17, wherein the adhesive material is epoxy-based and the projections are formed of silicon-bronze alloy.

19. The article of manufacture claimed in claim 17, wherein the layer presents a planar sheet, and the projections present a meshed wire configuration.

20. The article of manufacture claimed in claim 19, wherein the layer comprises a plurality of discontinuous radial bands of adhesive material.
